(19) United States
(12) Patent Application Publication
(10) Pub. No.: US 2004/0222708 A1
(43) Pub. Date: Nov. 11, 2004

(54) Electric oscillatory machine

(76) Inventors: Barry Reginald Hobson, North Lake (AU); Angelo Paoliello, Sawyer Valley (AU)

Correspondence Address: MCGARRY BAIR PC, 171 MONROE AVENUE, N.W., SUITE 600, GRAND RAPIDS, MI, 49503, US

(21) Appl. No.: 10/781,923

(22) Filed: Feb. 18, 2004

Related U.S. Application Data
(63) Continuation-in-part of application No. 09/723,816, filed on Nov. 28, 2000, now Pat. No. 6,703,724.
Application No. 09/723,816 is a continuation-in-part of application No. 09/196,274, filed on Nov. 19, 1998, now Pat. No. 6,160,328.

(30) Foreign Application Priority Data
Nov. 13, 1998 (AU) PP 7124

(51) Int. Cl. H02K 33/00; H02K 35/00; F16D 13/68

(52) U.S. Cl. 310/36

(57) ABSTRACT

An oscillatory machine comprises a support having a load carrying surface and an opposite surface. Also included is an electric motor having an airgap through which lines of magnetic flux extend, and an armature coupled to the support. The armature is provided with at least two electrically conductive paths, each having at least one current carrying segment disposed in the airgap and substantially perpendicularly intersected by the lines of magnetic flux to produce thrust forces which act to move the armature and the support in two dimensions in a plane. Finally, a bearing support system suspends the armature in the air gap and is disposed between the support and the armature.

### CROSS-REFERENCE TO RELATED APPLICATIONS

This application is a continuation-in-part application of U.S. patent application Ser. No. 09/723,816, filed on Nov. 22, 2002, now pending, which is a continuation-in-part application of U.S. patent application Ser. No. 09/196,274, filed on Nov. 19, 1998, now U.S. Pat. No. 6,160,328, which claims the benefit of Australian Provisional Application filed on Nov. 13, 1998.

### BACKGROUND OF THE INVENTION

1. Field of the Invention

The applicant is knowledgeable of the design and operation of pulverizing mills used to grind mineral samples into a fine powder. The pulverizing mill together with many other types of machines require an orbital or vibratory motion in order to work. These machines include for example screens for screening particles, cone crushers for crushing rocks, and shakers and stirrers for shaking and stirring laboratory solutions, biological/medical products and specifications, and the like.

The invention relates to an electric machine operable as a motor to provide motion required to drive a pulverizing mill but which can alternatively be operated as a generator to provide electricity or an electrical load.

2. Description of the Related Art

Traditionally, the orbital or vibratory motion required on such machines is imparted to an object by attaching the object to a spring mounted platform to which is coupled an eccentrically weighted shaft driven by a motor; or, via bearings to an eccentric shaft driven by a motor. A mechanical coupling such as a gear box, belt, or universal joint is used to couple the output of the motor to the shaft.

However, the very motion that these machines are designed to produce also leads to their inevitable and frequent failure. Specifically, the required orbital or vibratory motion leads to fatigue failure in various components of the machines including mechanical couplings, transmissions, bearings, framework and mounts. The cost of repairing such failures is very high. In addition to the cost of repairing the broken component(s) substantial losses can be incurred due to down time in a larger process in which the failed machine performs one or more steps. A further limitation of such machines is that they produce fixed orbits or motions with no means of dynamic control (i.e. no means of varying orbit path while machine is running).

The present invention has evolved from the perceived need to be able to generate orbital or vibratory motion without the limitations and deficiencies of the above described prior art.

It is also well known in the art that an electric machine can operate as a motor when driven by electricity to provide a mechanical output such as a rotation of a shaft and, can operate as an electricity generator or electrical load when a mechanical input is provided such as a rotation of a shaft by crank, water wheel, or similar means.

### SUMMARY OF THE INVENTION

According to the invention there is provided an oscillatory machine comprising a support having a load carrying surface and an opposite surface. An electric motor has an airgap through which lines of magnetic flux extend, and an armature is coupled to the support. The armature is provided with at least two electrically conductive paths each having at least one current carrying segment disposed in the airgap and substantially perpendicularly intersected by the lines of magnetic flux to produce thrust forces which act to move the armature and thus the support in two dimensions in a plane. A bearing support system suspends the armature in the air gap and the bearing support system is disposed between the support and the armature.

Preferably the bearing support system comprises at least three ball roller assemblies, each ball roller assembly comprising a ball roller and a roller support surface on which the ball roller rolls. The roller support surface is located in a plane between the support and the armature.

Preferably each roller support surface comprises a planar surface that is substantially parallel to a plane containing the support.

In an alternate embodiment the roller support surface comprises one or more planar surface portions that lie in planes non-parallel to the plane containing the support.

In a further alternate embodiment each roller support surface comprises a concavely curved surface.

Preferably the oscillatory motor further comprises a motor body and a restraint system coupled between the support and the motor body, restraining twisting motion of the support.

Preferably the restraint system comprises a parallelogram arrangement of arms comprising first and second arms pivotally coupled together intermediate their respective lengths, each of the first and second arms having one end resiliently coupled to the motor body.

Preferably the parallelogram arrangement of arms further comprises a third arm pivotally coupled to an opposite end of the first arm, a fourth arm pivotally coupled to an opposite end of the second arm, and a fifth arm pivotally coupled to both the third and fourth arms and rigidly coupled to the support.

Preferably the oscillatory motor further comprises a hub extending axially of and attached to the support and the armature.

Preferably the fifth arm is rigidly attached to the hub.

Preferably the oscillatory motor further comprises a self centering system which returns the support to a central position relative to the electric motor when the electric motor is not energized.

In one embodiment, the self support system comprises a rod extending through the hub and resiliently coupled at opposite ends to the support and the motor body.

### BRIEF DESCRIPTION OF THE DRAWINGS

In the drawings:

FIG. 1A is a schematic representation of the first embodiment of the electric machine.

FIG. 1B is an enlarged view of section A-A of FIG. 1A.

FIG. IC is a graphical representation of a three-phase AC voltage/current supply.

FIG. 2 is a partial cut away perspective view of a second embodiment of the electric machine.

FIG. 3 is a partial cut away perspective view of a third embodiment of the electric machine.

FIG. 4 is a partial cut away perspective view of a fourth embodiment of the electric machine.

FIG. 5 is a partial cut away perspective view of a fifth embodiment of the electric machine.

FIG. 6 is a partial cut away perspective view of a sixth embodiment of the electric machine.

FIG. 7 is a partial cut away perspective view of a seventh embodiment of the electric machine.

FIG. 8A is a partial cut away perspective view of an eighth embodiment of the electric machine.

FIG. 8B is a perspective view of a support incorporated in the embodiment shown in FIG. 8A.

FIG. 9 is a schematic representation of the machine depicted in FIG. 1A showing the invention as an electricity generator.

FIG. 10 is a schematic representation of a further simplified version of the machine depicted in FIG. 9.

FIG. 11 is a perspective view of a portion of the machine depicted in FIG. 5 showing the invention as an electricity generator.

FIG. 12 is an exploded view of an oscillatory motor incorporating a ninth embodiment of the electric machine.

FIG. 13 is a side view of the oscillatory motor shown in FIG. 12.

FIG. 14 is a bottom plan view of the oscillatory motor shown in FIGS. 12 and 13.

FIG. 15 is an exploded view of a magnet assembly incorporated in the oscillatory motor.

FIG. 16 is an exploded view of an armature incorporated in the oscillatory machine.

FIG. 17 is a partial section view of the oscillatory motor shown in FIGS. 12-16.

FIG. 18 is a partial section view of a second embodiment of the oscillatory motor.

FIG. 19 is a partial section view of a third embodiment of the oscillatory motor.

FIG. 20 is a section view of a fourth embodiment of the oscillatory motor.

### DESCRIPTION OF THE PREFERRED EMBODIMENT

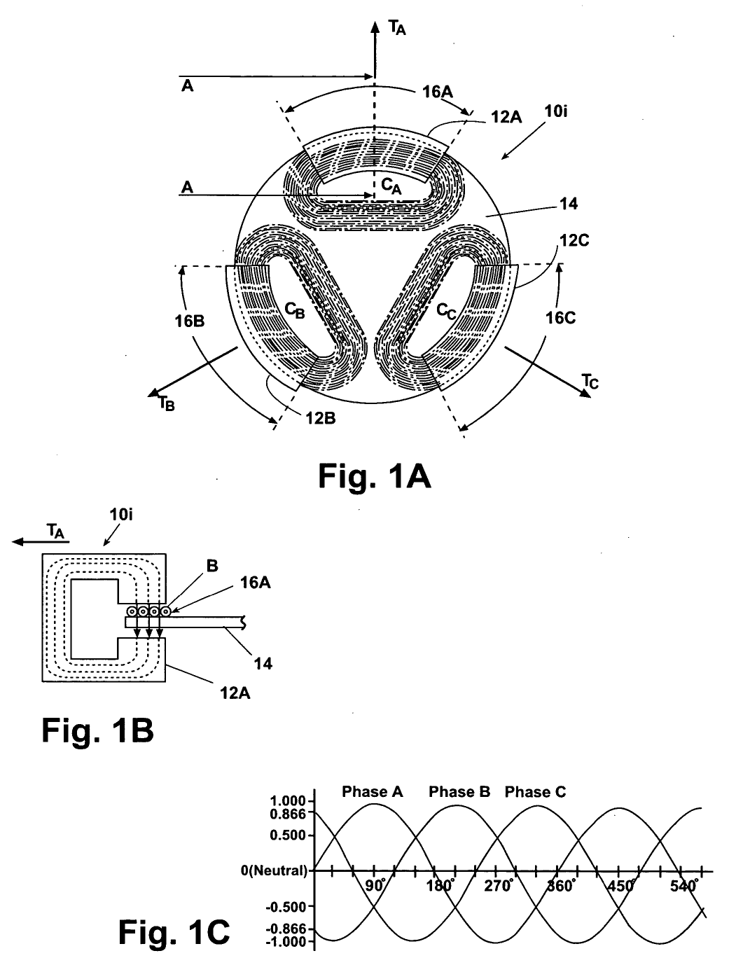

Referring to FIGS. 1A and 1B, a first embodiment of the machine operates as an electric motor 10; includes magnetic field means in the form of three separate magnets 12A-12C (referred to in general as “magnets 12”) each producing a magnetic field having lines of flux B extending in the first direction perpendicularly into the page. A support in the form of disc 14 is provided that is capable of two-dimensional motion relative to the magnets 12 in the plane or the page. The disc 14 is provided with a minimum of two, and in this particular case three, electrically conductive paths in the form of conductor coils C_{A}, C_{B} and C_{C} (referred to in general as “conductive paths”; “coils”; or “paths” C).

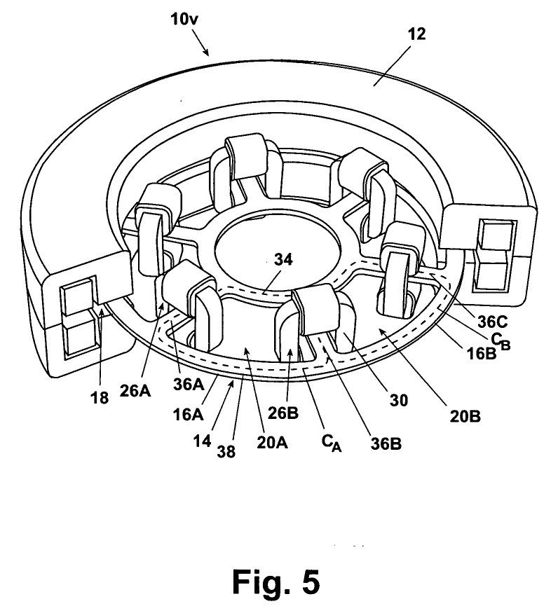

Throughout this specification and claims the expression “the disc (or support) . . . is provided with . . . electrically conductive paths” is to be construed as meaning that either the disc (support) has attached, fixed or otherwise coupled to it electrical conductors forming the paths, as shown for example in FIGS. 1-4; or, that the disc (support) is made of an electrically conductive material and does by itself provide or constitute the electrically conductive paths as shown for example in FIGS. 5-8B.

Consider for the moment the conductor path or coil C_{A} and its corresponding magnet 12A. The path C_{A} as a segment 16A that extends through the magnetic field B produced by the magnet 12A in a second direction preferably, but not essentially, perpendicular to the first direction, i.e. perpendicular to the lines of flux produced by the magnet 12A in a second direction preferably, but not essentially, perpendicular to the first direction, i.e. perpendicular to the lines of flux produced by magnet 12A. If a current with a positive polarity is caused to flow in coil C_{A} say in the clockwise direction then the interaction of that current and magnetic field will produce a transverse thrust force T_{A} that acts on the disc 14 via the segment 16A. In this instance the precise direction of the thrust force T_{A} is provided by the right hand rule, assuming the flux B is in a direction into the page and thus, in this scenario will be directed in the upward direction in the plane of the page. The direction of thrust can also be determined with this right hand rule if the current is flowing counter clockwise in the coils or if the flux B is flowing upwards into the plane of the page. If in a further arrangement the current is provided with a negative polarity then a left-hand rule is used to determine the direction of thrust forces. The remaining coils or paths C_{B} and C_{C} likewise have corresponding segments 16B and 16C that extend in a direction perpendicular to the lines of magnetic flux of corresponding magnets 12B and 12C. Therefore, if electric currents are caused to flow in paths C_{B} and C_{C}, say in the clockwise direction, then similarly thrust forces T_{B} and T_{C} will be produced that act on the disc 14 via the respective segments 16B and 16C and in directions as dictated by the right hand rule. The segments 16A and 16B (and indeed in this instance also segment 16C) are located relative to each other so that their respective thrust forces T_{A} and T_{B} do not lie on the same axis or line. By having two thrust forces directed along different axes or lines, two-dimensional motions of the disc 14 can be achieved. Moreover, the path of motion of the disc 14 can be controlled by varying the magnitude and/or phase relationship of the electric currents flowing through the segments 16A-16C (referred to in general as “segments 16”).

In its simplest form, consider the situation where electric current is supplied to coil C_{A} only in the clockwise direction. Thrust force T_{A} is produced which causes the disc 14 to move in the direction of the thrust force. If coil C_{A} is now de-energized and coil C_{B} energized the disc 14 will move in a direction parallel to thrust force TB which is angularly offset by 120° from the direction of thrust force T_{A}. If coil C_{B} is de-energized and coil C_{C} energized the disc 14 will move in the direction of corresponding thrust force T_{C} which is angularly offset by a further 120° from thrust force T_{B}. By repeating this switching process, it can be seen that the disc 14 can be caused to move in a triangular path in a plane, i.e. it can move with two-dimensional motion in a plane. A digital controller (not shown) can be used to sequentially provide DC currents to coils C_{A}-C_{C} at various switching rates and various amplitudes for control of the motion of the disc 14. Also, the path or motion can be modified by causing an overlap in currents supplied to the segments. For example, current can be caused to flow in both coils C_{A} and C_{B} simultaneously, perhaps also with modulated amplitudes.

In this embodiment, three separate coils C_{A}, C_{B}, and C_{C} are shown. However, as is clearly apparent to produce two-dimensional motion in a plane a minimum of two coils, for example C_{A} and C_{B}, only is sufficient, provided the respective thrust forces T_{A} and T_{B} do not act along the same axis or line. Stated another way, what is required for a two-dimensional motion is that there is a minimum of two coils relatively disposed so that when their thrust forces are acting on the disc 14 they cannot produce a zero resultant thrust force on the disc (except when both the thrust forces themselves are zero).

Rather than the triangular motion described above, the disc 14 can be caused to move with a circular orbital motion by energizing the coils C_{A}, C_{B} and C_{C} with AC sinusoidal currents that are 120° (electrical) out of phase with each other.

It is to be appreciated that the circular orbital motion is not a rotary motion about an axis perpendicular to the disc 14, i.e. the disc 14 does not act as a rotor in the conventional sense of the word. In the present embodiment, if each of the coils C_{A}, C_{B}, and C_{C} were connected to different phases in the three phase sinusoidal AC current supply, of the type represented by FIG. 1C, the disc 14 would move in a circular orbital motion. This arises because the total resultant force, i.e. the combination of T_{A}, T_{B} and T_{C} is of constant magnitude at all times. The difference in phase between the coils C_{A}, C_{B} and C_{C} leads to the direction of the resultant force simply rotating about the center of the disc 14. This is an angular linear force, not a torque. The frequency of the motion of disc 14 is synchronous with the frequency of the AC current to the coils C_{A}, C_{B} and C_{C}. Thus, the motion frequency of disc 14 can be varied by varying the frequency of the supply voltage/current. A non-circular orbit can be produced by providing coils C_{A}, C_{B}, and C_{C} with currents that are other than 120° out of phase and/or of different amplitude.

In the embodiment shown in FIGS. 1A and 1B, the disc 14 is made of a material that is an electrical insulator and the coils C_{A}, C_{B} and C_{C} are wire coils that are fixed for example by glue or epoxy to the disc 14. The coils C_{A}, C_{B} and C_{C} have separate leads (not shown) that are coupled to a voltage supply (not shown). The magnets 12 have a C-shaped section as shown in FIG. 1B providing an air gap 18 through which lines of flux B extend. The segments 16 of each of the coils C are located in the air gap 18 of their corresponding magnets 12.

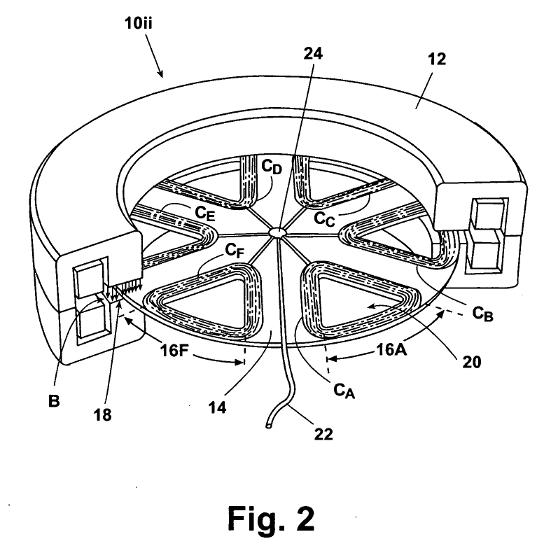

FIG. 2 illustrates an alternate form of the motor 10ᵢᵢ which differs from the embodiment shown in FIG. 1 by replacing the separate magnets 12A, 12B and 12C with a single magnet 12 in the form of a Cockcroft ring and in which the disc 14 is provided with six conductive paths or coils —C_{A}-C_{F}. In order to reduce weight, the disc 14 is provided with six apertures or cut-outs 20 about which respective ones of conductive paths C extend. A multi-conductor cable 22 extends from a six phase power supply (not shown) to a central point 24 on the disc 14 where respective conductor pairs fan out to the coils C. The six phases required for the coils C_{A}-C_{F} can be obtained from a conventional star or delta three phase power supply by tapping off the reverse polarities of each phase.

In the motor 10ᵢᵢ shown in FIG. 2, each conductive path or coil C has a segment 16 that is disposed in the air gap 18 of the magnet 12. As with the previous embodiment, when current is caused to flow through the segments 16, a transverse force is created due to the interaction between the current and the magnetic flux B, the transverse force is acting on the disc 14 via the respective segments 16. It will be recognized that many segments are relatively located to each other so that their respective thrust forces are not parallel to each other in the plane of motion of the disc 14, i.e. their respective thrust forces do not lie along the same axis or line. For example the thrust force arising from current flowing through segment 16A lies on a different line to the thrust force arising from current flowing through segment 16F. The same holds for say segments 16A and 16C; and 16B and 16D. Consequently, the disc 14 is again able to move in a two-dimensional planar motion. The fact that thrust forces produced on diametrically-opposed segments are parallel does not negate the existence of other thrust forces that do not act along the same axis or line to enable the generation of the two-dimensional planar motion.

In order to avoid rubbing of components and reduce friction, the disc 14 may be supported on one or more resilient mounts, e.g. rubber mounts or springs so that it is not in physical contact with the magnet 12.

It would be understood that a conventional grinding head can be attached to the disc 14 of the machine 10ᵢᵢ in FIG. 2 for grinding a mineral sample. The orbital motion of the disc 14 would produce the required forces to cause a puck or grinding rings within the grinding head to grind a mineral sample. However, unlike conventional pulverizing mills, the frequency of the orbital motion can be changed at will by varying the frequency of the AC supply to the coils C. Further, the actual path and/or diameter of motion can be varied from a circular orbit to any desired shape by varying the phase and/or magnitude relationship between the currents in the coils C while the machine is in motion.

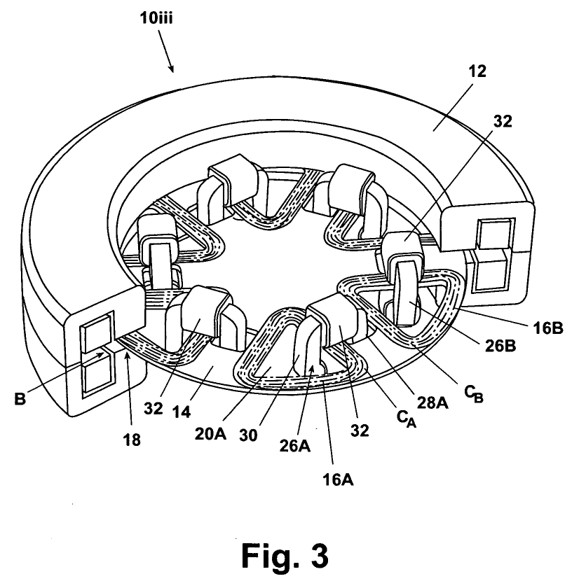

A further embodiment of the electric motor 10ᵢᵢᵢ is shown in FIG. 3. In the electric motor 10ᵢᵢᵢ instead of each coil C being physically connected by a conductor to a current supply through multi-connector cable 22, current for each coil C is produced by electromagnetic induction using transformers 26A-26E (referred to in general as “transformers 26”). Further, the conductive paths (i.e. coils C) are now multi-turn closed loops. The disc 14 includes in addition to the apertures 20, a plurality of secondary apertures 28A-28F (hereinafter referred as “secondary apertures 28”), one secondary aperture 28 being located adjacent a corresponding primary aperture 20 with the apertures 20 and 28 being separated by a portion of the coils C extending about the particular primary aperture 20. Each transformer 26 has a core 30 and a primary winding 32. The primary winding 32 may be in the form of two physically separated though electrically connected coils located one above and one below the plane of the disc 14. The core 30 of each transformer links with one of the coils C so that coil C acts as secondary windings. This interlinking is achieved by virtue of the core 30 looping through adjacent pairs of apertures 20 and 28. It will be appreciated that a current flowing through the primary winding 32 of a transformer 26 will induce the current to flow about the linked coil C. The apertures 20 and 28, and core 30 are relatively dimensioned to ensure that the disc 14 does not impact or contact the core 30 as it moves in its two-dimensional planar motion. The transformers 26 are supported separately from the disc 14 and thus do not add any inertial effects to the motion of the disc 14. By using induction to cause currents to flow through the coils C the need to have a physical cable or connection as exemplified by multiconductor cable 22 in the motor 10ᵢᵢ is eliminated. This is seen as being particularly advantageous as cables or other connectors may break due to fatigue caused by motion of the disc 14 and also add weight and thus inertia to the disc 14.

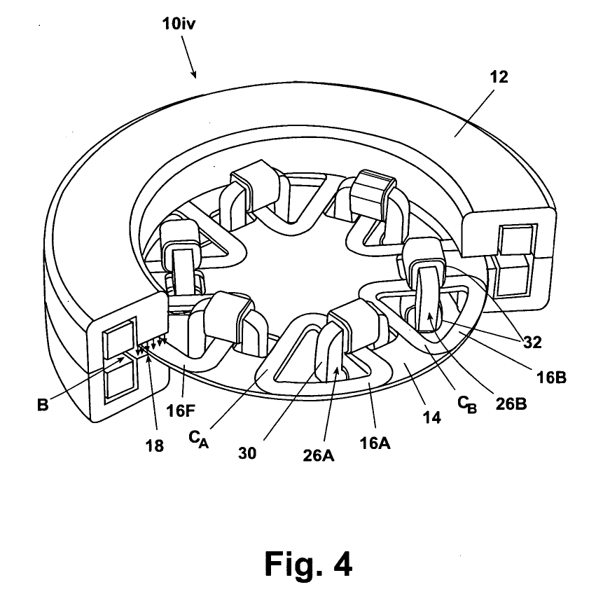

FIG. 4 illustrates a further embodiment of the electric motor 10ᵢᵥ. This motor differs from motor 10ᵢᵢᵢ by forming the respective conductive paths C with a single turn closed loop conductor rather than having multiturn coils as previously illustrated. Replacing a multi-turn wire coil with a single solid loop has no adverse effects. The single solid loop behaves the same as the multi-turn coil with the same total cross-sectional area, where the current in the single loop equals the current in each turn of the coil multiplied by the number of turns, thereby giving the same resultant thrust force. Again, as with the previous embodiments, the motion of the disc 14 can be controlled by the phase and/or magnitude relationship of electric currents flowing through the segments 16 of each conductive path, i.e. conductive loop C.

FIG. 5 illustrates yet a further embodiment of the electric motor 10ᵥ. This is a most remarkable embodiment as the conductive paths C are electrically connected together. In the motor 10ᵥ, the disc 14 is now in the form of a wheel having a central portion in the form of a hub 34, a plurality of spokes 36 extending radially outwardly from the hub 34 and an outer peripheral rim 38 joining the spokes 36. Apertures 20 similar to those of the previous embodiments are now formed between adjacent spokes 36 and the sectors of the hub 34 and rim 38 between the adjacent spokes 36. The disc 14 is made of an electrically conductive and most preferably non-magnetic material such as aluminum. The current paths are constituted by the parts of the disc 14 surrounding or bounding an aperture 20. For example, conductive path C_{A} (shown in phantom) comprises the spokes 36A and 36B and the sectors of the hub 34 and 38 between those two spokes. Conductive path C_{B} is constituted by spokes 36B and 36C and the sectors of the hub 34 and 38 between those two spokes. The sector of the rim 38 between adjacent spokes form the segment 16 for the conductive path containing those spokes. It is apparent that adjacent conductive paths C share a common spoke, (i.e. have a common run or log). Each transformer 26 links with adjacent apertures 20 and has, passing through its core 30 one of the spokes 36. Consider for the moment transformer 26B. The core of this transformer passes through adjacent apertures 20A and 20B with the spoke 36B extending transversely through the core 30 of transformer 26B. The current induced into spoke 36B by the transformer 26B is divided between current paths C_{B} and C_{A}. Thus the transformer 26B, when energized, induces a current to flow through both paths C_{A} and C_{B}. In like fashion, each of the transformers 26 can induce the current to flow in respective adjacent conductive paths C. The state of the transformers will determine the current division between adjacent conductive paths C. Hence, the sectors of the rim 38 between adjacent spokes 36 and the currents flowing through them act in substance the same as the segments 16 in the motors 10ᵢ-10ᵢᵥ.

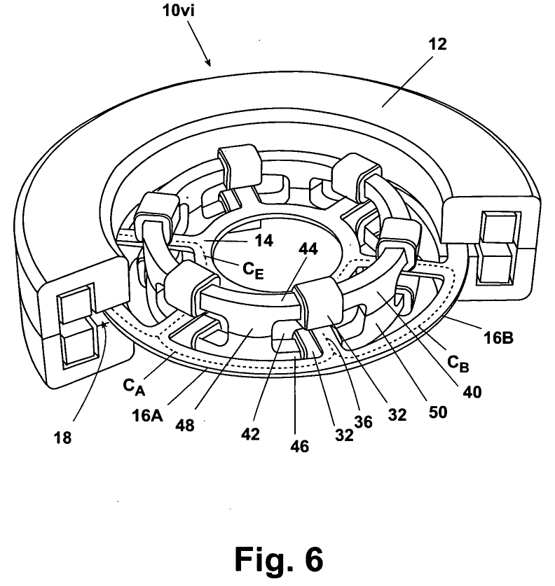

FIG. 6 illustrates a further embodiment of the electric motor 10ᵥᵢ. This motor differs from electric motor 10ᵥ by replacing the separate transformers 26 with a multi-phase toroid shaped transformer dubbed a “transoid” 40. The transoid 40 can be viewed as a ring of magnetically permeable material formed with a number of windows 42 and arranged so that separate conductive spokes 36 pass through individual different windows 42. Each window 42 is bound by opposed branches 44 and 46 that extend in the plane of the disc 14 and opposed legs 48 and 50 that extend perpendicularly to and join the opposed branches 44 and 46. Primary windings 32 are placed on each of the opposed branches 44 and 46 for every window 42. (Although it should be understood that primary winding can be placed anywhere within the window i.e., 44, 46, 48, 50 with one or more primary windings being utilized in various embodiments). Primary windings 32 are coupled to a six phase current supply in a manner so that the windings 32 for each window 42 are coupled to a different phase. Current flowing through the primary windings 32 sets up lines of magnetic flux circulating about the windows 42. This flux in turn induces the current to flow in the spoke 36 passing through that window 42 and the conductive path C to which that spoke 36 relates. It will be recognized that the majority of the flux generated about adjacent windows 42 will circulate through the common adjacent leg 48.

In comparison with the electric motor 10ᵥ shown in FIG. 5, the use of the transoid 40 makes more efficient use of its core because flux is shared from one or more primary coils. That is, magnetic flux induced by currents in primary coils about adjacent windows 42 can be shared through the common leg 48. Indeed more distant primary coils can contribute to the flux in that leg.

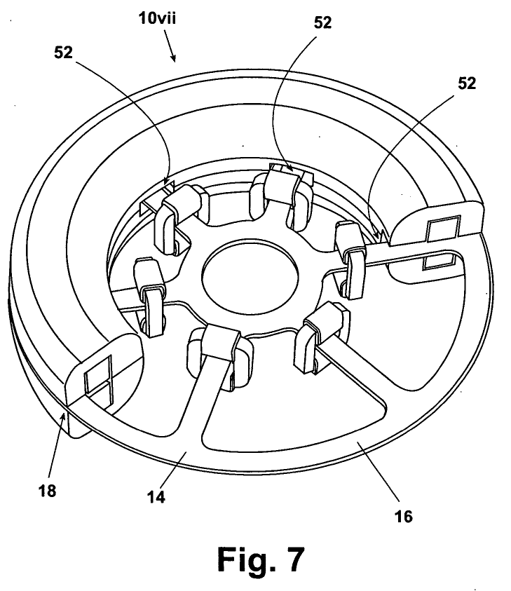

A further embodiment of electric motor 10ᵥᵢᵢ is shown in FIG. 7. This embodiment differs from the motor 10ᵥ shown in FIG. 5 in the configuration of the Cockcroft ring 12. In this embodiment, the air gap 18 of the Cockcroft ring is on the outer circumferential surface of the Cockcroft ring rather than on the inside surface as shown in FIG. 5. Additionally, a plurality of radially extending slots 52 are formed in the Cockcroft ring 12 through which the spokes 36 can pass. The slots 52 must be sufficiently wide to not inhibit the motion of the disc 14.

In the embodiments of the electric motor 10ᵢᵢ-10ᵥᵢᵢ there are six segments 16 through which current flows to produce respective transverse forces that act on the disc 14. However, this can be increased to any number. Conveniently however the number of segments 16 will be related to the number of different phases available from a power supply used for driving the motor 10. For example, the motor 10 can be provided with twelve segments 16 through which current can flow by use of a twelve-phase supply. In this instance, therefore, transformers are used to induce currents to flow in each segments, there will be required either twelve separate transformers 26 as shown in FIGS. 4, 5, and 7 or alternately a twelve window transoid 40.

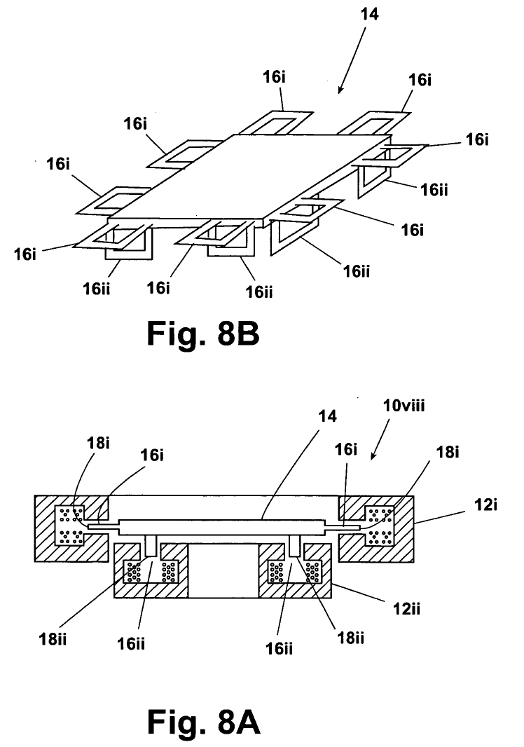

In the afore-described embodiments, the motion of the support 14 is a two-dimensional motion in one plane. However, motion in a second plane or more nonparallel planes can also be easily achieved by the addition and/or location of further segments 16 in the second or additional planes and, further means for producing magnetic fields perpendicular to the currents flowing through those additional segments. An example of this is shown in the motor 10ᵥᵢᵢᵢ in FIGS. 8A and 8B in which the support 14 has one set of segments 16ᵢ and a first plane (coincident with the plane of the support 14) and a second set of segments 16ᵢᵢ that extend in a plane perpendicular to the plane of the support 14. The motor 10ᵥᵢᵢᵢ has first magnet 12ᵢ having an air gap 18ᵢ in which the segments 16ᵢ reside, and a second magnet 12ᵢᵢ having an air gap 18ᵢᵢ in which the second set of segments 16ᵢᵢ reside. Thus, in this embodiment, the support 14 can move with a combined two-dimensional motion in the plane of the support 14 and an up and down motion in a second plane perpendicular to the plane of the support 14. Thus, in effect, in this embodiment, the support 14 can float in space by action of the thrust forces generated by the interaction of the current flowing through segments 16ᵢᵢ and the magnetic field in the air gap of the magnet 12ᵢᵢ. It is also apparent from the previous motor embodiments 10ᵢ-10ᵥᵢᵢ that the segments 16ᵢ and 16ᵢᵢ of the motor 10ᵥᵢᵢᵢ can be individually supplied with electrical currents. In such instances the motion of the support 14 in the second plane is not just limited to a perpendicular up and down movement but can include motion with two degrees of freedom. As is apparent from FIG. 8B the support 14 need not be circular in shape but can be square (as in FIG. 8B) or any other required/desired shape. For the sake of clarity the means for supplying current to the segments 16ᵢ, 16ᵢᵢ have not been shown. The currents may be provided by direct electrical connection to a current source as in the embodiments 10ᵢ and 10ᵢᵢ or via induction as in embodiments 10ᵢᵢᵢ to 10ᵥᵢᵢ.

From the above description it will be apparent that embodiments of the present invention have numerous benefits over traditional machines used for generating vibratory or orbital motion. Clearly, as the motion of the disc 14 is non-rotational, there is no need for bearings, lip seals, gearboxes, eccentric weights or cranks. In addition, the inertial aspects of rotation, such as a time to accelerate to speed and gyroscopic effects are irrelevant. In the embodiments of the machine 10ᵢᵢ-10ᵥᵢᵢ induction is used to cause current to flow in the segments 16 and thus commutators, brushes, and flexible electric cables arc not required. It will also be apparent that the only moving part of the machine 10 is either the support 14 or the magnetic field means 12. When it is the support 14 itself that carries the electric current as shown in embodiments 10ᵥ-10ᵥᵢᵢ this support 14 may be made from one piece only say by punching or by casting. In these embodiments the disc 14 must be made from an electrically conductive material and most preferably a non-magnetic material such as aluminum, copper or stainless steel. When the machine 10 is used to generate an orbital motion from imparting to another object (for example a grinding head) there can be a direct mechanical coupling by use of bolts or screws.

The motor 10 is a force driven machine and the force it delivers is essentially unaltered by its movement. There is a small degree of back EMF evident, however the tests indicate that this is almost negligible, especially when compared with conventional rotating motors. As such, the motor 10 is able to deliver full force regardless of whether the disc 14 is moving or not. For this reason, current drawn by the motor 10 is relatively unaffected by the motion of the disc 14. This enables the motion of the disc 14 to be resisted or even stalled with negligible increase in current draw and therefore negligible increase in heat build-up.

In the conventional mechanical orbital or vibratory machines, the orbital or vibratory motion is usually fixed with no variation possible without stopping the machine to make suitable adjustments. With the motor 10ᵢ the orbit diameter is proportional to the force applied, which in turn is proportional to the currents supplied. Therefore the orbit diameter can be controlled by varying the supply voltage that regulates the current in the segment 16. This results in a linear control with instant response available, independent of any other variable. As previously mentioned, the orbit frequency is synchronous with the frequency of the supply voltage, so that orbit frequency can be varied by varying the supply frequency. The motor 10 also allows one to avoid undesirable harmonics. A common problem with conventional out of balance drive systems is that as the motor builds up speed it can pass through frequency bands coinciding with the actual harmonic frequencies of various attached mechanisms that can then lead to uncontrolled resonance that can cause damage to the machine or parts thereof. The disc 14 however is able to start at any desired frequency and does not need to ramp up front zero speed to a required speed. In this way any undesired harmonics can be avoided. Particularly, the motor 10 can be started at the required frequency with a zero voltage (and hence zero orbit diameter) and then the voltage supply can be increased until the desired orbit diameter is reached.

If no control over the orbit diameter or frequency is required, the motor 10 can be connected straight to a mains supply so that the frequency will be fixed to the mains frequency. Nevertheless, full control is not difficult or costly to achieve. Existing motor controllers which utilize relatively simple electronics with low computing requirements can be adapted to suit the motor 10. Because voltage supplies can be controlled electronically, the motor 10 can be computer driven. This enables preset software to be programmed and for safety features to be built into the supply controller allowing its operation to be reprogrammed at any time. The addition of feedback sensors can allow various automatic features such as collision protection. When the disc 14 is mounted on rubber supports, it can be considered as a spring-mass system. As such, it will have a harmonic or resonance frequency at which very little energy is required to maintain orbital motion at that frequency. If the machine 10 is only required to run at one frequency, the stiffness of the rubber supports can be chosen such that resonance coincides with this frequency to reduce the power losses and hence improve the machines efficiency.

While the description of the preferred embodiments mainly describes the disc 14 as moving in an orbit, depending on the capabilities of the controller for the supply, i.e. the ability to vary phase relationships and amplitudes of the supply current, the disc 14 can produce any shaped motion within the boundaries of its maximum orbit diameter.

Embodiments of the motor 10 can be used in many different applications such as pulverizing mills as previously described, cone crushers, sieve shakers, vibrating screens, vibratory feeders, stirrers and mixers, orbital sanders, orbital cutting heads, polishers and specific tools requiring a non-rotational motion, blood product agitators for blood storage systems, motion and stirring device for cell culture fermentors and bioreactors, tactile devices and motion alarms for personal pagers and mobile communication devices, planetary drive system for digital media storage systems or read heads for digital media system, friction welders for plastic components, dynamic vibration input device for testing components and structures, dynamic vibratory material feeder for hoppers and chutes, vibration device for seismic surveying, vibration cancellation platform for sensitive equipment and vibration cancellation device included for pipe-work attached to pumps, orbital/planetary motion device for acoustic speakers.

Further in the described embodiments the motion of the support/disc 14 relative to the magnetic field means 12 is achieved by having the support/disc 14 movable and the magnetic field means 12 fixed. However this can be reversed so that the support/disc 14 is fixed or stationary and the magnetic field means 12 moves. This may be particularly useful when it is required to impart and maintain, for example a vibratory motion to a large inertial mass. Also, it is preferred that the segments 16 extend through the magnetic field B at right angles to maximize the resultant thrust force. Clearly embodiments of the invention can be constructed where the segments 16 are not at right angles, though it is preferable to have some component of their direction at right angles to the field B to produce a thrust force.

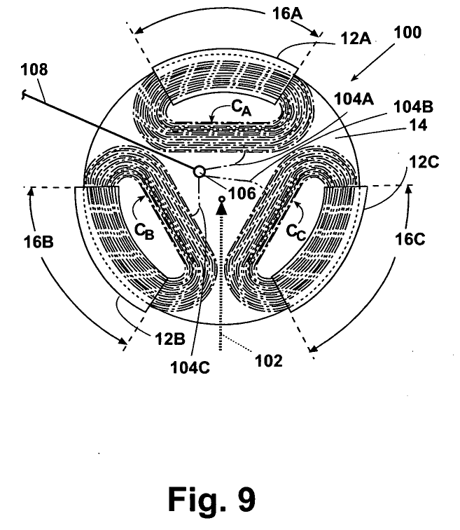

Referring now to FIG. 9, the invention can also operate as an electricity generator 100. In FIG. 9, the mechanical input is represented schematically by the vector 102.

The mechanical input 102 is attached to the disc 14 through a conventional connection. The input 102 and the disc 14 are connected such that the movement of the disc 14 is coextensive with the plane of the disc 14. The mechanical input 102 is provided by a conventional apparatus capable of producing a two-dimensional motion, such as a triangular or circular orbital motion. Electrical leads 104A-104C connect the coils C_{A}-C_{C} to a junction 106, to which is connected a multi conductor cable 108. The movement of the input 102 will create a corresponding movement of the disc 14. Movement of the disc 14 within the flux B of the magnets 12A-12C will induce a current in the coils C_{A}-C_{C} which will be carried through the leads 104A-104C, junction 106, and cable 108.

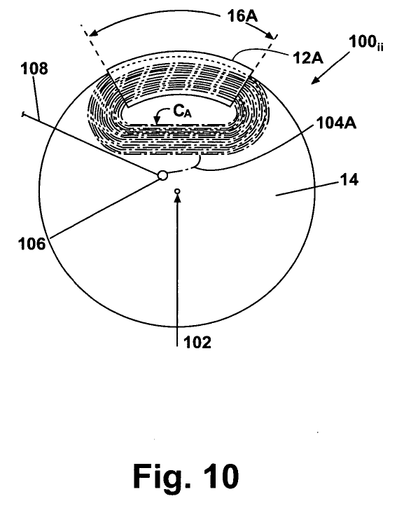

A more basic version of the machine 100ᵢ is depicted in FIG. 10. The machine 100ᵢ differs from the machine 100 of FIG. 9 by the provision of a single electrical path only constituted by coil C_{A}. It would be appreciated that the motion provided by input 102 causing movement of the disc 14 in a plane would also lead to the induction of a current in the coil C_{A} which is carried through lead 104A, junction 106, and cable 108.

In a further variation of the embodiment shown in FIG. 10 a second electrically conductive path or coil can be provided on disc 14 diametrically opposed to coil C_{A}. All other parameters being equal, the currents induced in coils C_{A} and the diametrically opposed coil would have the same waveform but be out of phase by 180° with each. If such currents were added they will produce a nil result. However, the currents from the coils can be tapped individually. This is in contrast to the situation where the machine having diametrically opposed coils is operated as a motor in which case the thrust forces rising from currents flowing through the coils would be diametrically opposed and, if of the same magnitude, would result in no motion, and if not of same amplitude, would cause a reciprocating motion rather than a orbital motion as ordinarily required for a pulverizing mill.

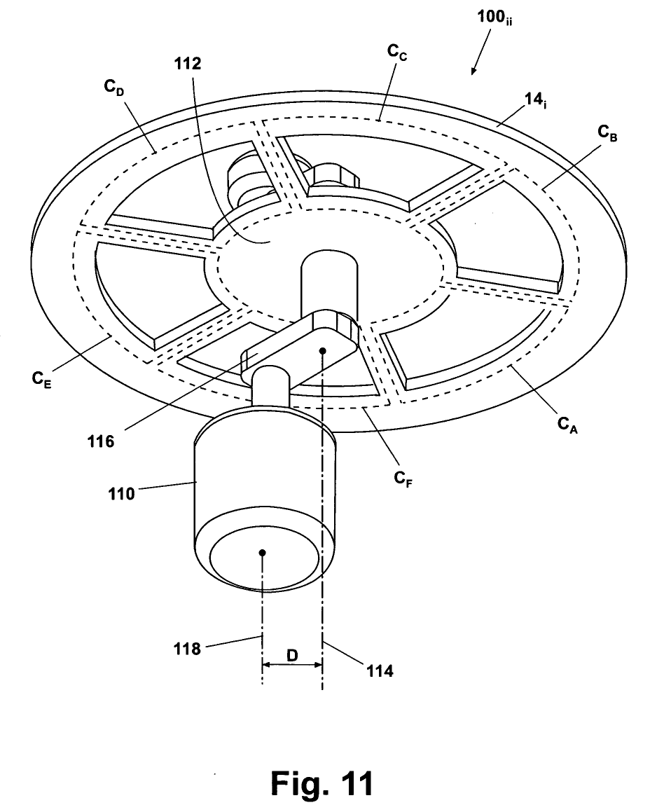

FIG. 11 illustrates how the machine 100ᵢᵢ of FIGS. 5 and 6 can be operated as a generator by coupling of the disc 14ᵢ to a mechanical crank 110. The disc 14ᵢ differs marginally from the disc 14 depicted in FIGS. 5 and 6 by forming the hub support as a solid web 112 to provide for coupling of the crank 110. The crank 110 is attached to a central axis 114 of the disc 14ᵢ that is offset by distance D by a crank arm 116 from a drive axis 118. The crank 110 is rigidly attached to the disc 14ᵢ so that the application of torque about the axis 118 causes an orbital motion in a plane of the support 14ᵢ.

As with the machine depicted in FIGS. 5 and 6 individual wound cores or the “transoid” (depicted in FIG. 6) can be associated with the disc 14ᵢ to effectively tap off currents induced in the separate paths C_{A}-C_{F} constituted by the support 14ᵢ.

The machine when configured as a generator illustrated in FIGS. 9-11 can be mechanically directly coupled to the motor form of the machine depicted in FIGS. 1-8 by a mechanical linkage between the respective discs 14. Indeed such coupling has been made in order to allow measurement of the efficiency of the motor by comparing electrical power, output and output current/voltage waveform in the generator with the electrical input to the motor.

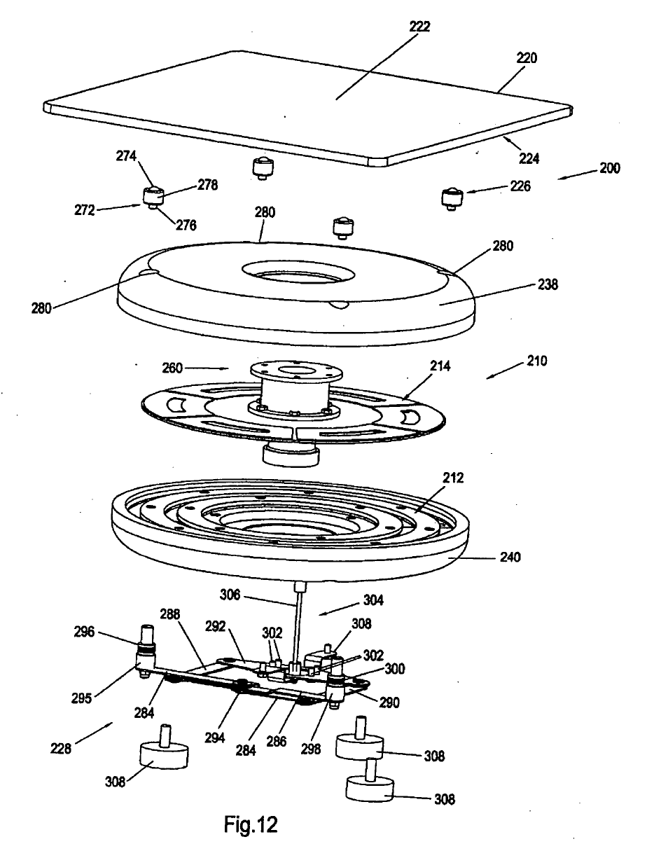

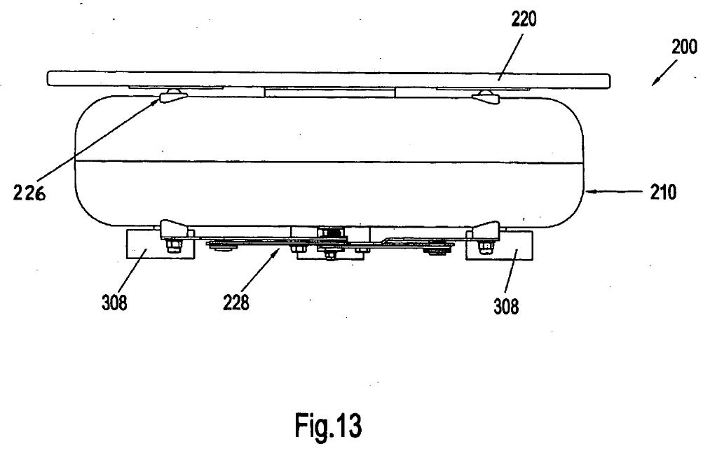

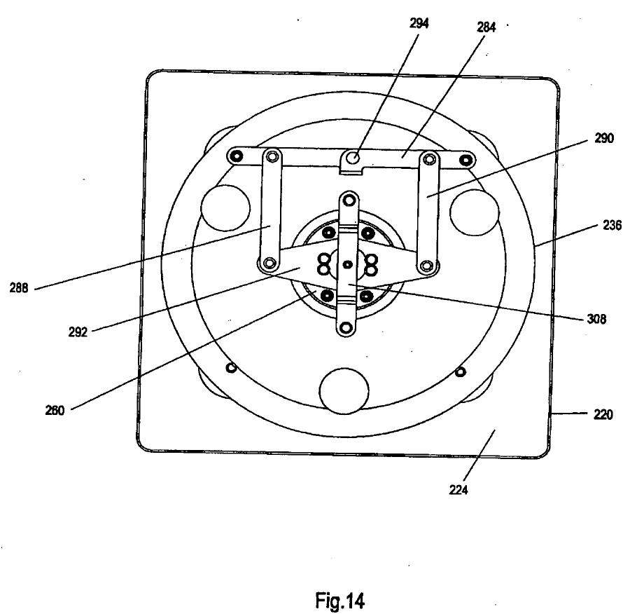

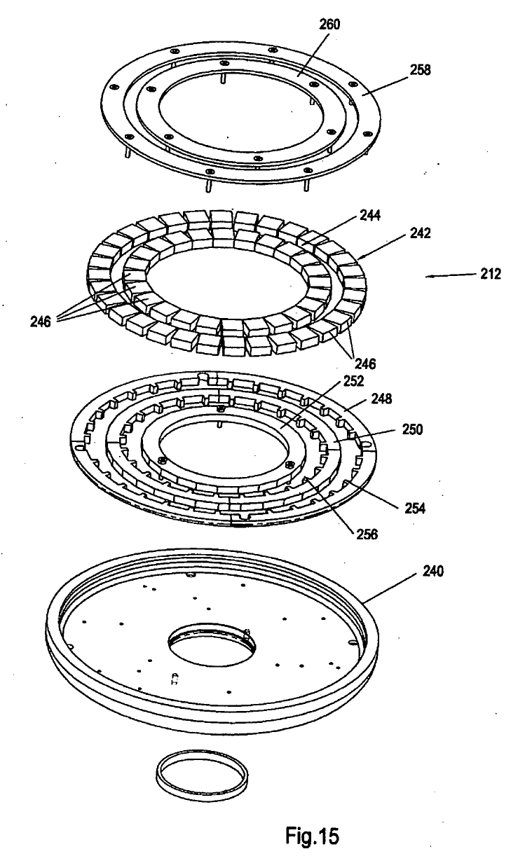

FIGS. 12-17 depict an embodiment of an oscillatory machine 200 that incorporates yet a further alternate embodiment of an electric motor 210. As explained in greater detail below, the electric motor 210 differs in essence from the motors 10-10ᵥᵢᵢᵢ by the provision of a magnet assembly 212 which provides two concentric airgaps 218a and 218b (referred to in general as “airgaps 218”) and by forming an armature disc (hereinafter referred to as “armature 214”) 214 having a plurality of electrically conducting paths C_{A}-CF where each connective path C has two current carrying segments 216₁ᵢ and 216₂ᵢ one in each of the airgaps 218a and 218b respectively. The oscillatory machine 200 also comprises a support or platform 220 having a load carrying surface 222 and an opposite undersurface 224 that is coupled to the armature 214. The armature 214 is suspended in the airgap 218 by a bearing support system 226 that is located between the platform 220 and the armature 214. The oscillatory machine 220 also includes a restraint system 228 that is coupled between the electric motor 210 and the support 220 to restrain twisting motion of the support 220.

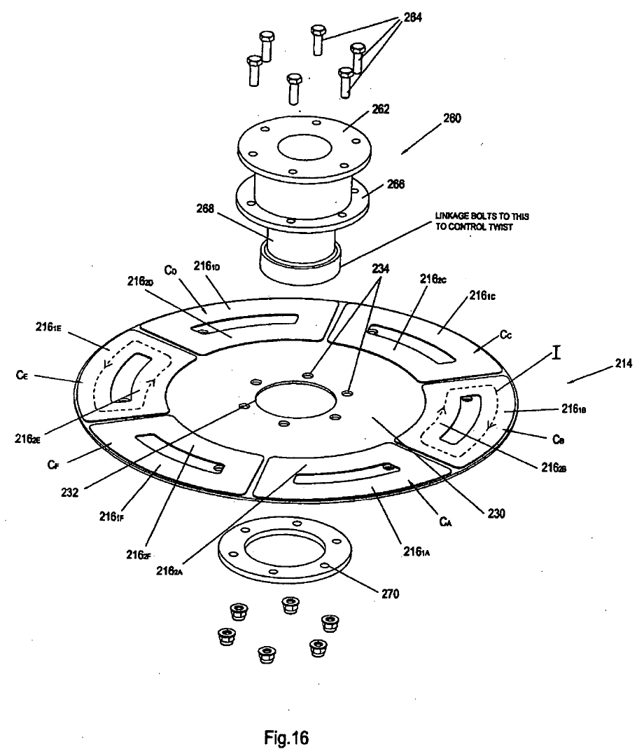

Referring to FIG. 16, the armature 214 may be made from a circular disc 230 of non-conductive rigid material such as a polymer compound or fiberglass where the conductive paths C are formed by flat substantially rectangular wire coils fixed about the periphery of the disc. Forming the paths C as rectangular coils produces the two current carrying segments 216₁ᵢ and 216₂ᵢ each of which extend with a circumferential aspect to the disc 230. It will further be appreciated that a current circulating within any particular path moves in opposite linear directions in each of the segments 216₁ᵢ and 216₂ᵢ. For example consider current I circulating in a clockwise direction in path C_{B}. The current in segment 216_{1b} flows in an opposite linear direction to the current in segment 216_{2b}. If desired a second set of conductive paths may be attached to an underside of the disc 230. The armature 214 is provided with a central hole 232 with a plurality of smaller bolt holes 234 formed thereabout.

Referring to FIGS. 12, 15 and 17 the motor 210 further comprises a donut-shaped body 236 that is radially split into identical upper and lower shells 238 and 240 respectively. The body 236 houses the magnet assembly 212. The magnet assembly 212 comprises in each of the shells 238 and 240 an outer ring 242 and inner ring 244 of permanent magnets 246. The magnets 246 are retained in their respective rings 242 and 244 by an outer locating band 248, an intermediate locating band 250 and an inner locating band 252. The outer band 248 and intermediate band 250 are provided with a plurality of inwardly projecting keys 254 and 256 respectively. The ring of magnets 242 is held between the bands 248 and 250 with the keys 254 located between adjacent magnets 246. The inner ring of magnets 244 is located between the intermediate band 250 and inner band 252 with respective keys 256 located between adjacent magnets 246. The outer, intermediate and inner bands 248, 250 and 252 are made from a non-magnetic material and preferably a plastics material. The inner ring 252 is fastened by screws or bolts to the lower shell 240.

An outer annular pole piece 258 made from a magnetizable material overlies the outer ring of magnets 242 and is bolted to the shell 240. Similarly, an inner annular pole piece 260 overlies the inner ring of magnets 244 and is bolted to the shell 240.

Each of the magnets 246 in the outer ring 242 is arranged with the same polar orientation. The magnets 246 in the inner ring 244 are also each orientated with the same polar orientation but opposite to the orientation of the magnets in the outer ring 242. The magnet assembly within the upper shell 238 is identical to that of the lower shell thereby producing the first airgap 218a extending between the outer ring of magnets 242 in the upper and lower shells 238 and 240; and the second annular airgap 218b extending between the inner ring of magnets 244 in the upper and lower shells 238 and 240. The airgaps 218a and 218b are configured to substantially align with the current carrying segments 216₁ᵢ and 216₂ᵢ respectively. Due to the opposite polar orientation of the magnets within the inner and outer rings 242 and 244 the direction of magnetic flux B in the respective airgaps 218a and 218b is reversed. Moreover, the magnetic flux B forms a closed loop circulating through the magnet rings 242 and 244 and intervening portions of the upper and lower shells 238 and 240. As the current flowing through the segments 216₁ᵢ and 216₂ᵢ of any coil C is in opposite linear directions the thrust force created by the interaction of current flowing through each of the segments of any particular path C and the magnetic flux B act in the same direction on the portion of the armature 214 to which that particular path C is attached.

The platform 220 is coupled to the armature 214 by an axially extending hub 260. The hub 260 has a first mounting flange 262 at one end that is fastened against the undersurface 224 of the platform 220 by a plurality of bolts 264. The hub 260 includes a second flange 226 and a reduced diameter portion 268. The reduced diameter portion 268 passes through the central hole 232 in the armature 214 with the flange 266 placed against an upper surface of the disc 230. A mounting ring 270 is passed over the reduced diameter portion 268 on the opposite side of the disc 230 so that the armature 214 is effectively clamped between the flange 266 and the ring 270.

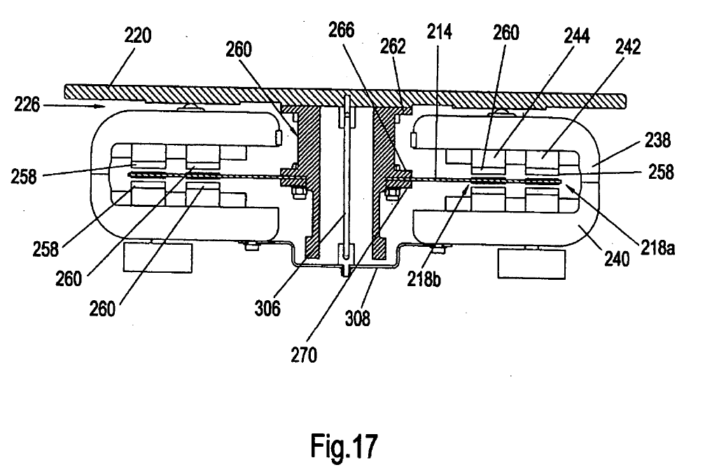

Reverting to FIG. 12, one form of the bearing support system 226 comprises at least three (in this instance four) ball roller assemblies 272. Each ball roller assembly 272 comprises a ball roller 274 and a roller support surface 276 on which the ball 274 rolls. In this particular embodiment, the surface 276 is a lower surface of a cage or cup 278 which retains the ball 274. The surface 276 is concavely curved to seat the ball 274 allowing the ball 274 to roll in any direction (ie about any axis) within the cage 278. Each of the assemblies 272 sits in a corresponding recess 280 formed on the upper shell 238 of the motor body 236. The roller surfaces 276 are all disposed within a common plane that is parallel to the plane of the platform 220 and the plane of the armature 214. It should be appreciated, particularly from FIG. 17, that the bearing support system 226 effectively suspends the armature 214 within the airgap 218 via the support 220 and the hub 260. The bearing support system 226 enables near frictionless two-dimensional motion of the platform 220 in a plane (in x/y directions). The motion of the platform 220 is without any motion in the vertical plane, ie without any z motion.

The restraint system 228 restrains twisting motion of the support 220. The restraint system is coupled between the platform 220 and the motor body 236 and, in this embodiment is in the form of a plurality of pivotally coupled arms. Moreover, the arms are arranged in a parallelogram type configuration and comprises a first arm 284, a second arm 286, a third arm 288, a fourth arm 290 and a fifth arm 292. The first and second arms 284 and 286 are coupled together about their mid-point by a pivot pin or bolt 294. Further, the arm 284 crosses over the arm 286 in the region of the pivot pin 294. One end 295 of the first arm 284 is resiliently coupled to the lower shell 240 via a rubber mounting block 296. Similarly, one end 298 of the second arm 286 is resiliently coupled to the lower shell 240 via a rubber mounting block 300. The arm 288 is pivotally coupled at opposite ends to arms 286 and 292, and arm 290 is pivotally coupled at opposite ends to the arm 284 and 292. The arm 292 is in turn rigidly coupled to the reduced diameter portion 268 of the hub 260 via bolts 302. The restraint system 282 allows the platform 220 and the armature 214 to move in a plane while restraining twisting motion which could rise for example if a corner of the platform 220 is heavily loaded or restrained.

A self-centering system 304 acts to return the platform 220 to a central position relative to the motor 210 when the machine 200 is not energized. The self-centering system comprises a rod 306 which is resiliently coupled at opposite ends to the undersurface 224 of the platform 220 and to the lower shell 240 via a bracket 308. The rod 306 extends axially through the hub 260. Due to its resilient mounting the bar 306 is continuously biased to a vertical position within the hub 206. When the oscillatory machine 200 is in operation with the platform 220 moving in a plane, the bar 306 is displaced from its vertical position (although at times may travel through this position). When the machine 200 is de-energized, the only force acting on the platform 220, other than gravity, will be that applied by the self centering system 304 which will return the bar 306 to its vertical position and thus the platform 220 to a central position relative to the machine 200.

A plurality of feet 308 is attached to an underside of the lower shell 240 and can be adjusted to enable leveling of the platform 220.

The principle of operation of the motor 210 in the machine 220 is identical to the motors described in relation to the embodiments depicted in FIGS. 1-11. The interaction of current flowing through the segments 216 and the magnetic flux extending through the airgaps 218 create thrust forces which act on the armature 214 to move it in two dimensions in a single plane. This motion is transferred to the support or platform 220 via the hub 260. The bearing support system 226 effectively suspends the armature 214 within the airgap 218 and provides near frictionless motion of the platform 220. In this particular embodiment, the platform 220 moves without any vertical motion.

The machine 200 is particularly well suited for the shaking of biological products such as blood and blood plasma that has benefits in terms of extending their viability. However the oscillatory machine 200 may be used for many other purposes as described hereinbefore. By appropriate control of the currents flowing through respective segments 216, the motion of the platform 220 can be precisely controlled. For example, but without limitation, the platform 220 may be controlled to move in a simple circular orbital motion, in the motion of a FIG. 8, or following the path of a star.

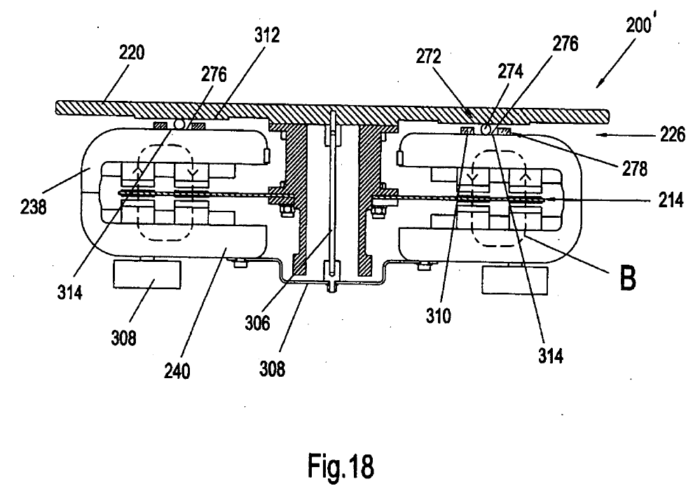

FIG. 18 depicts a further embodiment of the oscillatory machine 200 which differs from the machine 200 only in the form of the bearing support system 226 and the profile of the undersurface 224 of the platform 220. In this embodiment, the cage 278 is not in the form of a cup but rather a ring 310 having an inner diameter several times greater the diameter of the ball roller 274. Further, the undersurface 224 is provided with an integrally formed pad 312 that extends over the ring 310. Here, the ball 274 is free to roll anywhere within the confines of the ring 310 and bound between the pad 312 and a surface portion 314 of the upper shell disposed within the ring 310. The surface 314 in this embodiment constitutes the roll support surface 276. The roll support surface 276 is planar and parallel to the plane of the platform 220 and the armature 214. Accordingly the platform 220 again moves in two dimensions in a single plane.

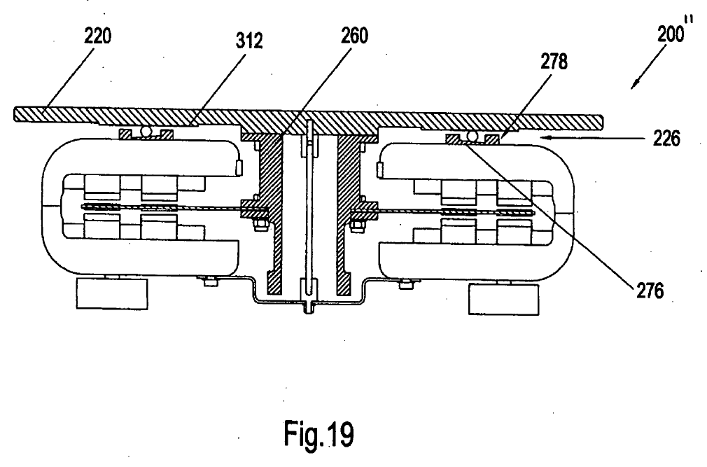

FIG. 19 depicts a further form of the oscillatory machine 200 with a modified form of bearing support system 226 that in this instance provides controlled limited vertical (Z) motion of the platform 220. This is achieved by forming the cage 278 with a support surface 276 that is sloping relative to the plane of the platform 220. Thus now, the ball rollers 274 can roll up and down the inclined support surface 276 introducing limited up and down motion of the platform 220. The degree of up and down motion is determined by the inclination of the surfaces 276. It should be noted however that appropriate dimensioning of the airgap 218 is required to ensure that the up and down motion of the platform 220 does not result in the armature 214 contacting the pole pieces 258.

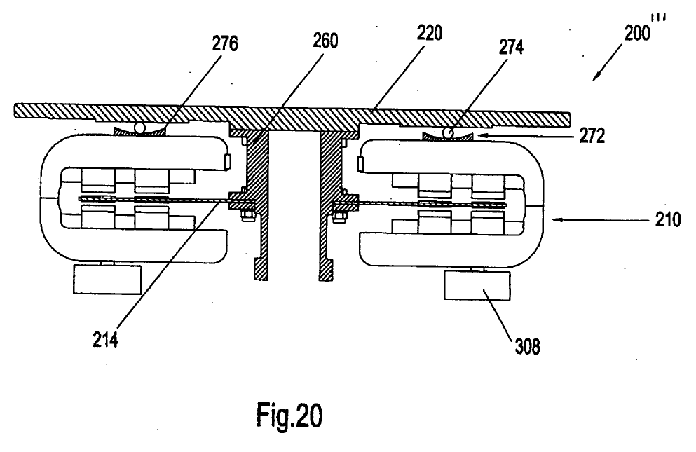

FIG. 20 depicts a further form of the oscillatory machine 200 with yet another embodiment of the bearing support system 226. Here, the cage 276 comprises a shallow cup or dish with a concavely curved roll support surface 276 and of a diameter several times that of the ball 274. This again provides limited vertical up and down motion. In this embodiment, the concavely curved support surface 276 together with the ball 276 also acts as a self-centering system returning the platform 220 to a central position relative to the motor 210 when the motor is not energized. Accordingly in this embodiment, the self-centering system 304 depicted in the embodiment shown in FIG. 12 is not required.

The oscillatory machine 200 may incorporate any of the electric motors 10-10ᵥᵢᵢᵢ described hereinbefore and illustrated in FIGS. 1-11.

While the invention has been specifically described in connection with certain specific embodiments thereof, it is to be understood that this is by way of illustration and not of limitation, and the scope of the appended claims should be construed as broadly as the prior art will permit.

We claim:

1. An oscillatory machine comprising a support having a load carrying surface and an opposite surface;
an electric motor having an airgap through which lines of magnetic flux extend, and an armature coupled to said support, said armature provided with at least two electrically conductive paths each having at least one current carrying segment disposed in said airgap and substantially perpendicularly intersected by said lines of magnetic flux to produce thrust forces which act to move said armature and thus said support in two dimensions in a plane; and,
a bearing support system suspending said armature in said air gap, said bearing support system disposed between said support and said armature.

2. The oscillatory machine of claim 1 wherein said bearing support system comprises at least three ball roller assemblies, each ball roller assembly comprising a ball roller and a roller support surface on which said ball roller rolls, said roller support surface located in a plane between said support and said armature.

3. The oscillatory machine of claim 2 wherein each roller support surface comprises a planar surface which is substantially parallel to a plane containing said support.

4. The oscillatory machine of claim 2 wherein said roller support surface comprises one or more planar surface portions which lie in planes non-parallel to said plane containing said support.

5. The oscillatory machine of claim 2 wherein each roller support surface comprises a concavely curved surface.

6. The oscillatory machine of claim 1 further comprising a motor body and a restraint system coupled between said support and said motor body restraining twisting motion of said support.

7. The oscillatory machine of claim 6 wherein said restraint system comprises a parallelogram arrangement of arms comprising first and second arms pivotally coupled together intermediate their respective lengths, each of said first and second arms having one end resiliently coupled to said motor body.

8. The oscillatory machine of claim 7 wherein said parallelogram arrangement of arms further comprises a third arm pivotally coupled to an opposite end of said first arm, a fourth arm pivotally coupled to an opposite end of said second arm, and a fifth arm pivotally coupled to both said third and fourth arms and rigidly coupled to said support.

9. The oscillatory machine of claim 8 further comprising a hub extending axially of and attached to said support and said armature.

10. The oscillatory machine of claim 9 wherein said fifth arm is rigidly attached to said hub.

11. The oscillatory machine of claim 1 further comprising a self centering system which returns said support to a central position relative to said electric motor when said electric motor is not energized.

12. The oscillatory machine of claim 12 further comprising a hub extending axially of and attached to said support and said armature and wherein said self centering system comprises a rod extending through said hub and resiliently coupled at opposite ends to said support and said motor.
